(19) United States
(12) Patent Application Publication
(10) Pub. No.: US 2026/0359060 A1
(43) Pub. Date: Nov. 12, 2026

(54) INDIRECT LOAD AND STORE OPERATIONS ON A LANE-WISE OPERATED SINGLE INSTRUCTION MULTIPLE DATA (SIMD) COPROCESSOR

(71) Applicant: QUALCOMM Incorporated, San Diego, CA (US)

(72) Inventor: Eric Wayne MAHURIN, Austin, TX (US)

(21) Appl. No.: 19/203,680

(22) Filed: May 9, 2025

(51) Int. Cl. G06F 9/38; G06F 9/30

(52) U.S. Cl. CPC G06F 9/38873; G06F 9/3001; G06F 9/30032; G06F 9/3853

(57) ABSTRACT

Techniques described herein are directed to a lane-wise single instruction multiple data (SIMD) coprocessor configured to receive a SIMD instruction packet including a load instruction and one or more register instructions. The SIMD coprocessor is further configured to execute the load instruction to obtain load data and provide the load data to the one or more register instructions, wherein execution of the load instruction occurs independent of an operation involving a port of a register file of the processing system. The SIMD coprocessor is further configured to execute the one or more register instructions to perform one or more operations on the load data and data stored on a SIMD register of the plurality of SIMD registers to generate a result.

### TECHNICAL FIELD

Aspects of the present disclosure generally relate to coprocessors and, more particularly, to executing load-store operations on a lane-wise operated single instruction, multiple data (SIMD) coprocessor.

### BACKGROUND

Coprocessors (e.g., hardware accelerators) may be used to support a main processor (e.g., central processing unit) of a processing system. For example, the main processor may offload computationally intensive tasks (e.g., matrix multiplication, vector processor) or applications to the coprocessor so that the main processor may perform more general-purpose processing. Coprocessors can perform tasks in parallel with the main processor, allowing for concurrent processing and faster execution of certain workloads (e.g., machine learning algorithms).

SIMD coprocessors have a parallel processing architecture that allows an operation to be simultaneously performed on multiple data elements. Thus, the parallel processing architecture allows SIMD coprocessors to efficiently process large data sets. SIMD coprocessors can, for example, include specialized instructions that may be optimized for vector operations (e.g., addition, multiplication).

### BRIEF SUMMARY

In one aspect, a processing system is provided. The processing system includes: a lane-wise single instruction multiple data (SIMD) coprocessor including a plurality of SIMD registers, each of the plurality of SIMD registers including a plurality of SIMD lanes, wherein the lane-wise SIMD coprocessor is configured to: receive a SIMD instruction packet including a load instruction and one or more register instructions; execute the load instruction to obtain load data and provide the load data to the one or more register instructions, wherein execution of the load instruction occurs independent of an operation involving a port of a register file; execute the one or more register instructions to perform one or more operations on the load data and data stored on one or more SIMD registers of the plurality of SIMD registers to generate a result, wherein the one or more operations occur independent of a cross-lane operation occurring between the plurality of SIMD lanes within each respective SIMD register of the one or more SIMD registers.

In another aspect, a processing system is provided. The processing system includes: a lane-wise single instruction multiple data (SIMD) coprocessor including a plurality of SIMD registers, each of the plurality of SIMD registers including a plurality of SIMD lanes, wherein the lane-wise SIMD coprocessor is configured to: receive a SIMD instruction packet including a store instruction and one or more register instructions; execute the one or more register instructions to perform one or more operations on data stored on one or more SIMD registers of the plurality of SIMD registers to generate a result, wherein the one or more operations occur independent of a cross-lane operation occurring between the plurality of SIMD lanes within each respective SIMD register of the one or more SIMD registers; provide, via the one or more register instructions, the result to the store instruction; and execute the store instruction to store the result, wherein execution of the store instruction occurs independent of an operation involving a write port of a register file.

In yet another aspect, a method performable by a lane-wise single instruction multiple data (SIMD) coprocessor is provided. The method includes: receiving a SIMD instruction packet including a load instruction and one or more register instructions; executing the load instruction to obtain load data and provide the load data to the one or more register instructions, wherein execution of the load instruction occurs independent of an operation involving a port of a register file; and executing the one or more register instructions to perform one or more operations on the load data and data stored on one or more SIMD registers of a plurality of SIMD registers of the lane-wise SIMD coprocessor to generate a result, wherein the one or more operations occur independent of a cross-lane operation occurring between the plurality of SIMD lanes within each respective SIMD register of the one or more SIMD registers.

The following description and the related drawings set forth in detail certain illustrative features of one or more aspects.

### BRIEF DESCRIPTION OF THE DRAWINGS

The appended figures depict certain features of one or more aspects of the present disclosure and are therefore not to be considered limiting of the scope of this disclosure.

FIG. 1 depicts a heterogeneous computing system including a main processor and a coprocessor according to various aspects of the present disclosure.

FIG. 2 depicts a SIMD coprocessor according to various aspects of the present disclosure.

FIG. 3 depicts a lane-wise SIMD coprocessor according to various aspects of the present disclosure.

FIG. 4 depicts connections between a memory device and SIMD lanes of a lane-wise SIMD register included in a lane-wise SIMD coprocessor according to various aspects of the present disclosure.

FIG. 5 depicts a system for performing intra-SIMD data movement for a lane-wise SIMD coprocessor according to various aspects of the present disclosure.

FIG. 6 depicts execution of a SIMD packet by a lane-wise SIMD coprocessor according to various aspects of the present disclosure.

FIG. 7 depicts a method for executing a SIMD instruction packet including a load instruction and one or more register instructions according to various aspects of the present disclosure.

FIG. 8 depicts a method for executing a SIMD instruction packet including a store instruction and one or more register instructions according to various aspects of the present disclosure.

FIG. 9 depicts an example processing system in which a heterogeneous computing system may be included according to various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide techniques for processing mixed precision SIMD instructions on a lane-wise operated SIMD coprocessor.

SIMD coprocessors typically include multiple SIMD registers, which are a type of processor register that can hold multiple data elements of the same data type. In this manner, SIMD instructions can simultaneously perform the same operation (e.g., addition, multiplication, comparison, etc.) on all the data elements in a given SIMD register. SIMD registers typically hold the multiple data elements in a vector-like structure. Each of the data elements included in the vector-like structure may be referred to as a lane through which data/instructions may flow.

A SIMD register typically supports cross-lane operations which, for example, may involve movement of data elements within the SIMD register. To facilitate such cross-lane operations, the SIMD register may include hardware (e.g., data buses) that allows the different lanes of the SIMD register to be in data communication with one another. The hardware is typically complex and presents challenges associated with scaling the SIMD register so that SIMD coprocessors can accommodate larger data sets that may be associated with more complex tasks (e.g., executing machine learning algorithms).

Example aspects of the present disclosure are directed to a lane-wise operated SIMD coprocessor. The lane-wise operated SIMD coprocessor includes multiple lane-wise SIMD registers. However, in contrast to SIMD registers included in traditional SIMD coprocessors, the different lanes within each respective lane-wise SIMD register are decoupled from one another. In this manner, each respective lane-wise SIMD register does not support cross-lane operations and, as a result, does not include the hardware (e.g., multiple data buses) that is included in conventional SIMD registers to facilitate such cross-lane operations.

Thus, the lane-wise operated SIMD coprocessor according to aspects of the present disclosure may be scaled more efficiently compared to traditional SIMD coprocessors. More specifically, the number of lanes that are included in each respective lane-wise SIMD register of the lane-wise SIMD coprocessor may be scaled (e.g., increased) more easily compared to conventional SIMD registers, because each lane-wise SIMD register of the lane-wise operated SIMD coprocessor disclosed herein does not support intra-SIMD movement (that is, movement of data from one SIMD lane to another SIMD lane) and therefore do not include the additional hardware (e.g., data buses and interconnects) and complexity associated with implementing such hardware for intra-SIMD movement. Furthermore, since each of the lane-wise SIMD registers is substantially wider (e.g., includes many multiples the number of SIMD lanes) compared to traditional SIMD registers, the lane-wise SIMD coprocessor may have a greater compute density (e.g., about 8 times) than traditional SIMD coprocessors.

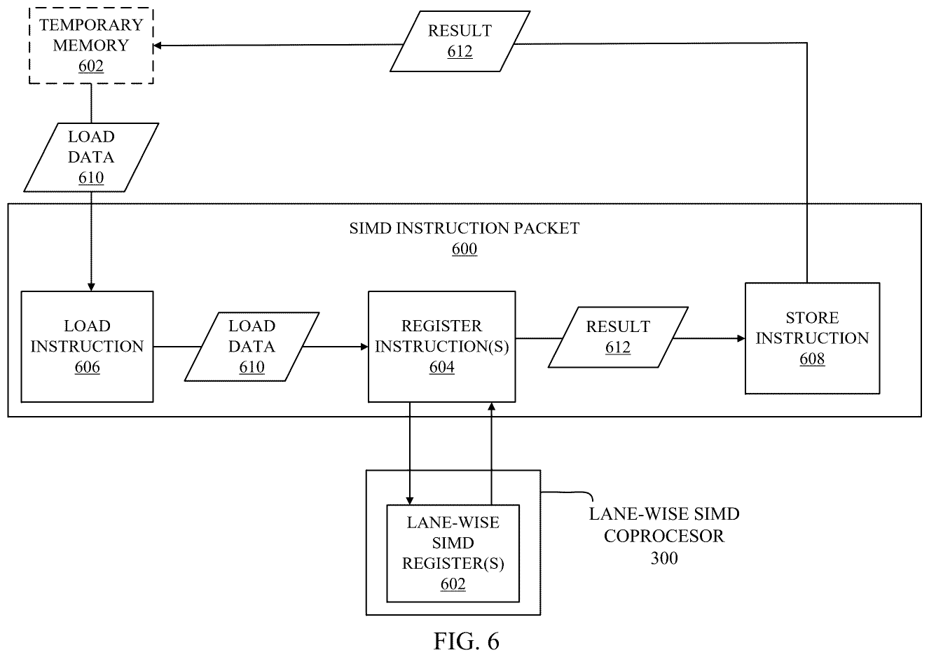

Example aspects of the present disclosure are further directed to techniques for executing a SIMD instruction packet including one or more register instructions (e.g., arithmetic, shift, sign, etc.) and at least one of a load instruction and a store instruction. As will be discussed in more detail with reference to FIG. 6, the load instruction and the store instruction may not directly access the lane-wise SIMD registers of the lane-wise SIMD coprocessor. Instead, the load instruction may provide load data to the register instruction(s) included in the SIMD instruction packet. Furthermore, based on the load data, the register instruction(s) may directly access the lane-wise SIMD registers to perform one or more operations (e.g., arithmetic, shift, sign) to the data stored in the different lanes of the lane-wise SIMD registers to generate a result that is then provided to the store instruction. By indirectly performing the load and store instructions via the register operation(s) that have direct access to the lane-wise SIMD registers, the disclosed techniques eliminate the need for the load instruction and the store instruction to access read/write ports of the register file of the lane-wise SIMD coprocessor and, in doing so, avoid the latency that is associated with traditional load store instructions that do access read/write pots of the register file. In this manner, the disclosed techniques provide a SIMD instruction packet having zero-packet latency load/store instructions, which can improve the efficiency (e.g., faster compute times) of the lane-wise SIMD coprocessor.

### Example Heterogeneous Computing System

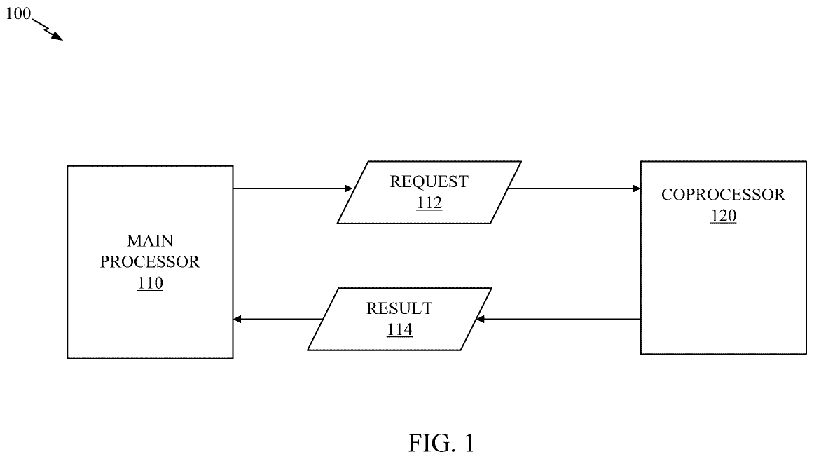

FIG. 1 depicts a heterogeneous computing system 100 according to aspects of the present disclosure. The heterogeneous computing system 100 may be used in a variety of different apparatuses (e.g., smartphones, tablets) and may be used for a variety of different applications (e.g., machine learning, digital signal processing, graphics processing). The heterogeneous computing system 100 includes a main processor 110 and a coprocessor 120. The main processor 110, which in some aspects may be a central processing unit (CPU), handles general-purpose computing tasks. The main processor 110 delegates computationally-intensive tasks (e.g., matrix multiplication, vector processing) to the coprocessor 120. Examples of the coprocessor(s) may include, without limitation, a graphics processing unit (GPU), a neural processing unit (NPU), and a tensor processing unit (TPU).

As illustrated, the main processor 110 may send a request 112 to the coprocessor 120. The request 112 may, for example, be for the coprocessor 120 to perform a computationally intensive task on data associated with a particular application (e.g., machine learning, digital signal processing) being executed by the heterogeneous computing system 100. The coprocessor 120 may communicate a result 114 of the computationally intensive task to the main processor 110.

### Example SIMD Coprocessor With SIMD Register Supporting Intra-SIMD Movement

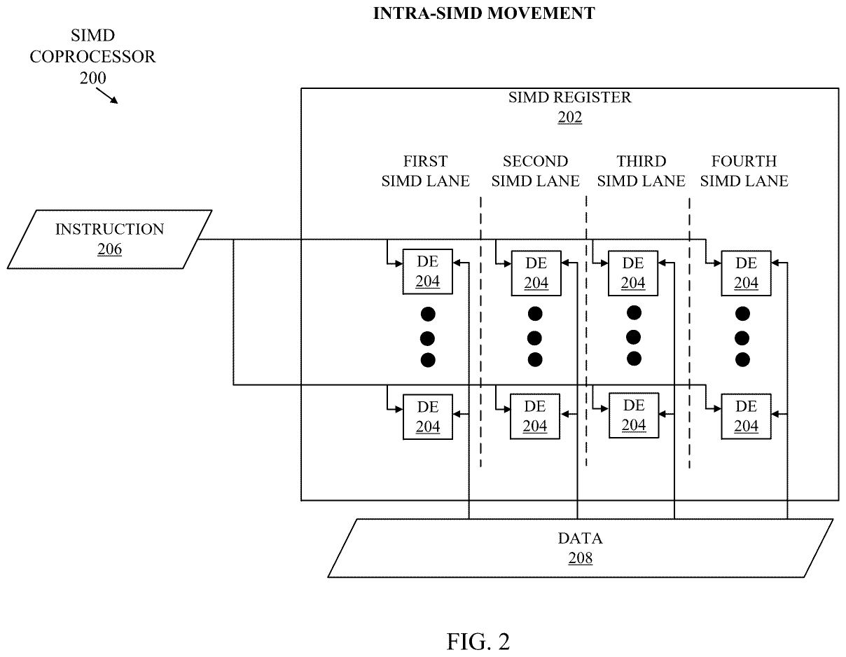

FIG. 2 depicts a SIMD coprocessor 200 according to aspects of the present disclosure.

The SIMD coprocessor 200 may include one or more SIMD registers 202 (one SIMD register 202 is shown in FIG. 2). Each of the SIMD registers 202 may include a plurality of data elements 204 (e.g., labeled “DE”). As illustrated, the plurality of SIMD data elements 204 may be arranged in an array (e.g., a vector arranged as columns and rows). Each respective column of the array may be referred to as a SIMD lane. In some aspects, each of the SIMD registers 202 may include four columns and four rows. In other aspects, each of the SIMD registers 202 may include more (or fewer) columns and rows. For instance, as illustrated in FIG. 2, each of the SIMD registers 202 may include a first SIMD lane, a second SIMD lane, a third SIMD lane, and a fourth SIMD lane.

In some aspects, the SIMD register 202 may be configured to receive an instruction 206 and data 208. More specifically, the instruction 206 may be provided as an input to each of the plurality of data elements. Additionally, a plurality of instances of data 208 may be provided as an input to each of the plurality of data elements 204.

The instruction 206 may correspond to an operation (e.g., multiply, add, etc.) that the SIMD registers 202 may simultaneously perform on the multiple instances of data 208. In some aspects, the operation may involve moving data between two respective SIMD lanes of the plurality of SIMD lanes included in the SIMD register 202. Such an operation may be referred to as a “cross-lane” operation. Furthermore, such movement of data (e.g., from one SIMD lane to another SIMD lane) may be referred to as “intra-SIMD” movement.

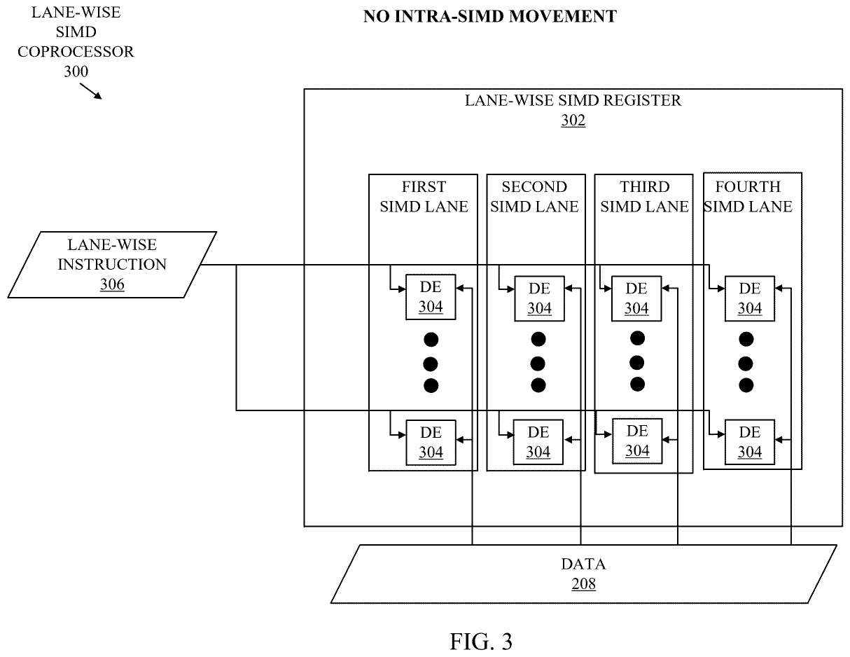

In some aspects, the SIMD register 202 may include hardware, such as dedicated data buses or interconnects, to facilitate intra-SIMD movement associated with cross-lane operations. As previously mentioned, SIMD registers, such as the SIMD register 202 of FIG. 2, that support cross-lane operations involving intra-SIMD movement may be difficult to scale. More specifically, the hardware associated with supporting cross-lane operations may become increasingly complex as the size (e.g., number of bits) of data increases. As will now be discussed with reference to FIG. 3, example aspects of the present disclosure are directed to a lane-wise SIMD coprocessor having a SIMD register that is configured for lane-wise only operations and therefore does not include the above-mentioned hardware for intra-SIMD movement and therefore can scale (e.g., to accommodate even larger data sets) more easily compared conventional SIMD coprocessors, such as the SIMD coprocessor 200 of FIG. 2.

### Example Lane-Wise SIMD Coprocessor with Lane-Wise SIMD Register Having No Intra-SIMD Movement

FIG. 3 depicts a lane-wise SIMD coprocessor 300 according to some aspects of the present disclosure.

The lane-wise SIMD coprocessor 300 may include one or more lane-wise SIMD registers 302 (one lane-wise SIMD register 302 is shown in FIG. 3). Each of the lane-wise SIMD registers 302 may include a plurality of data elements 304 (e.g., labeled “DE”). As illustrated, the plurality of data elements 304 may be arranged in an array (e.g., a vector arranged as columns and rows). Each respective column of the array may be referred to as a SIMD lane. In some aspects, each of the SIMD registers 302 may include four columns and four rows. In other aspects, each of the SIMD registers 302 may include more (or fewer) columns and rows. For instance, as illustrated in FIG. 3, each of the SIMD registers 302 may include a first SIMD lane, a second SIMD lane, a third SIMD lane, and a fourth SIMD lane. In other aspects, the lane-wise SIMD register 302 may include more or fewer SIMD lanes.

In some aspects, the lane-wise SIMD register 302 may be configured to receive a lane-wise instruction 306 and data 208. More specifically, the lane-wise instruction 306 may be provided as an input to each of the plurality of data elements 304. Additionally, a plurality of instances of data 208 may be provided as an input to each of the plurality of data elements 304.

The lane-wise instruction 306 may involve lane-wise operations that do not involve multiple SIMD lanes and therefore do not require intra-SIMD movement within the lane-wise SIMD register 302. It should be appreciated, however, that lane-wise operations may still include movement of data within a particular SIMD lane of the lane-wise SIMD register 302.

In contrast to the SIMD register 202 discussed above with reference to FIG. 2, the lane-wise SIMD register 302 in FIG. 3 does not include hardware, such as dedicated data buses or interconnects, to facilitate intra-SIMD movement associated with cross-lane operations. This is generally denoted by including a rectangular box around each of the plurality of SIMD lanes (e.g., First SIMD Lane, Second SIMD Lane, Third SIMD Lane, and Fourth SIMD Lane). In this manner, the lane-wise SIMD coprocessor 300, specifically the lane-wise SIMD register 302 thereof, may include less hardware compared to conventional SIMD coprocessors, such as the SIMD coprocessor 200 of FIG. 2, and therefore may scale (e.g., to accommodate even larger data sets) more easily compared conventional SIMD coprocessors.

The total number of SIMD lanes included in the lane-wise SIMD register 302 of FIG. 3 may be greater than the total number of SIMD lanes included in the SIMD register 202 of FIG. 2. For instance, in some aspects, the total number of SIMD lanes included in the lane-wise SIMD register 302 may be many multiples (e.g., at least 4 times as many) of the total number of SIMD lanes included in the SIMD register 202 of FIG. 2. For instance, in some aspects, the lane-wise SIMD register 302 may include as many as 1024 SIMD lanes. In this manner, the lane-wise SIMD coprocessor 300 may considered an ultra-wide SIMD coprocessor having no intra-SIMD movement within each of the lane-wise SIMD registers (e.g., lane-wise SIMD register 302) that are included in the lane-wise SIMD coprocessor 300.

As used herein, executing an instruction independent of a cross-lane operation occurring between the plurality of SIMD lanes of the lane-wise SIMD register 302 means that the instruction is executed within a single SIMD lane of the lane-wise SIMD register 302 and does not involve moving data from the single SIMD lane of the lane-wise SIMD register 302, nor does it involve retrieving data from another SIMD lane of the lane-wise SIMD register 302.

### Example Connections Between Memory and SIMD Lanes of Lane-Wise SIMD Register

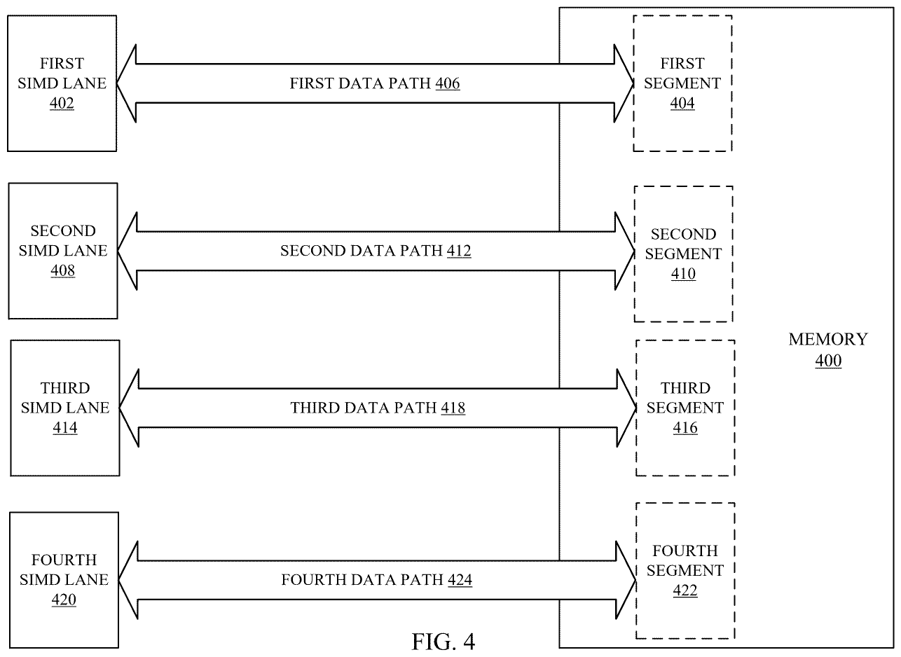

FIG. 4 depicts connections between memory 400 (e.g., main memory) and each of a plurality of SIMD lanes of a lane-wise SIMD register, such as the lane-wise SIMD register 302 of the lane-wise SIMD coprocessor 300 discussed above with reference to FIG. 3.

As illustrated, each of a first SIMD lane 402, a second SIMD lane 408, a third SIMD lane 414, and a fourth SIMD lane 420 may be in data communication with the memory 400 via independent data paths (e.g., denoted by double arrows extending between a respective SIMD lane and a respective segment of the memory 400). In some aspects, the data paths are decoupled from one another such that there is no data communication between two data paths extending between respective SIMD lanes and respective segments of the memory.

As illustrated, the first SIMD lane 402 may be in data communication with a first segment 404 of the memory 400 via a first data path 406. The second SIMD lane 408 may be in data communication with a second segment 410 of the memory 400 via a second data path 412 that is independent of the first data path 406. The third SIMD lane 414 may be in data communication with a third segment 416 of the memory 400 via a third data path 418 that is independent of the first data path 406 and the second data path 412. The fourth SIMD lane 420 may be in data communication with a fourth segment 422 of the memory 400 via a fourth data path 424 that is independent of each of the first data path 406, the second data path 412, and the third data path 418.

In some aspects, the different segments (e.g., first segment 404, second segment 410, third segment 416, and fourth segment 422) of the memory 400 may correspond to different address ranges of the memory 400. For instance, the first segment 404 of the memory 400 may correspond to a first subset of addresses of the memory 400, the second segment 410 may correspond to a second subset of addresses of the memory 400, the third segment 416 may correspond to a third subset of addresses of the memory 400, and the fourth segment 422 may correspond to a fourth subset of addresses of the memory. Furthermore, in some aspects, the different subsets of addresses (e.g., first subset, second subset, third subset, fourth subset) may be mutually exclusive. Stated another way, addresses included in one subset (e.g., first subset) of addresses of the memory 400 may not be included in any of the other subsets (e.g., second, third, fourth subsets) of the memory 400. In this manner, the different SIMD lanes (e.g., first SIMD lane 402, second SIMD lane 408, third SIMD lane 414, fourth SIMD lane 420) may be decoupled from one another (that is, not in data communication with one another) all the way to the memory 400.

Although FIG. 4 depicts four separate SIMD lanes, it should be appreciated that the connections between the memory 400 and a lane-wise SIMD register, such as the lane-wise SIMD register 302 of FIG. 3, may accommodate any suitable number of SIMD lanes. For instance, in some aspects, the lane-wise SIMD register may include 1024 different SIMD lanes. In such aspects, there may be 1024 separate data paths between the memory 400 and the lane-wise SIMD register to accommodate decoupling of the 1024 SIMD lanes all the way to the memory 400.

### Example System for Performing Data Movement for Lane-wise SIMD Coprocessors

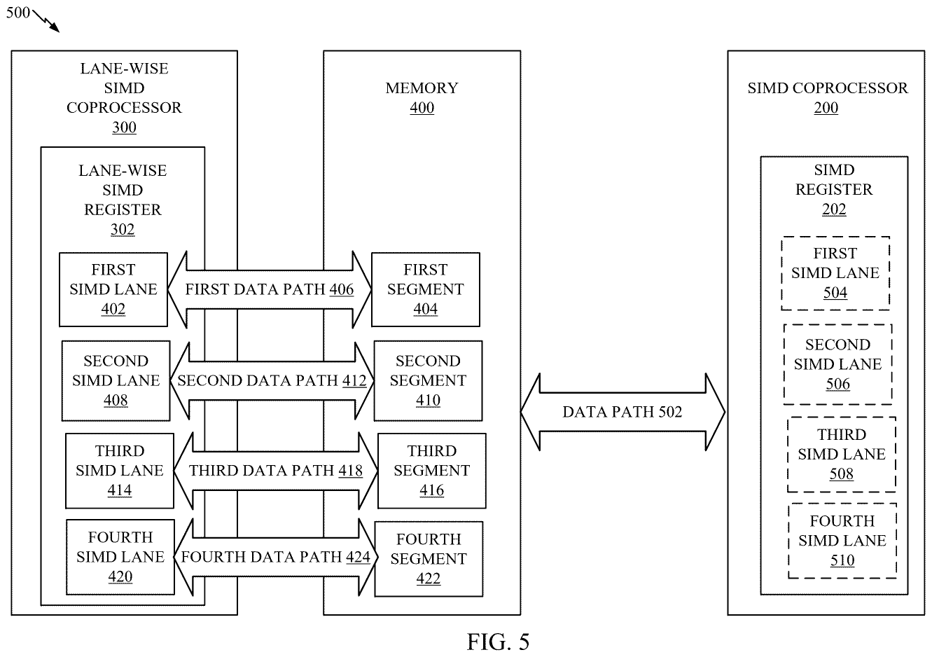

FIG. 5 depicts an example system 500 for performing data movement for lane-wise SIMD coprocessors according to some aspects of the present disclosure. For simplicity, the system 500 may include the lane-wise SIMD coprocessor 300 discussed above with reference to FIG. 3, the conventional SIMD coprocessor 200 discussed above with reference to FIG. 2, and the memory 400 discussed above with reference to FIG. 4.

In some aspects, intra-SIMD movement for the lane-wise SIMD register 302 of the lane-wise SIMD coprocessor 300 may be accomplished by moving data from the lane-wise SIMD coprocessor 300, which does not support intra-SIMD movement, to SIMD coprocessor 200, which does support intra-SIMD movement. As an example, to swap data included in the first SIMD lane 402 of the lane-wise SIMD register 302 with data included in the fourth SIMD lane 420 of the lane-wise SIMD register 302, data included in the first SIMD lane 402 may be communicated to the first segment 404 of the memory 400 via the first data path 406. Additionally, the data included in the fourth SIMD lane 420 of the lane-wise SIMD register 302 may be communicated to the fourth segment 422 of the memory 400 via the fourth data path 424.

As illustrated, the SIMD coprocessor 200, which does support intra-SIMD movement, may retrieve the data from the memory 400. For instance, the SIMD coprocessor 200 may retrieve data stored in the first segment 404 of the memory 400 as well as data stored in the fourth segment 422 of the memory 400. In some aspects, the SIMD coprocessor 200 may be in data communication with the memory 400 via a single data path 502. In other aspects, the SIMD coprocessor 200 may include multiple data paths between the memory 400 and respective SIMD lanes (e.g., first SIMD lane 504, second SIMD lane 506, third SIMD lane 508, and fourth SIMD lane 510) of the SIMD register 202 of the SIMD coprocessor 200.

In some aspects, the data retrieved from the first segment 404 of the memory 400 may be stored in the first SIMD lane 504 of the SIMD register 202. Additionally, the data retrieved from the fourth segment 422 of the memory 400 may be stored in the fourth SIMD lane 510 of the SIMD coprocessor 200.

In some aspects, the SIMD coprocessor 200 may be configured to execute one or more instructions associated with swapping the data stored in the first SIMD lane 504 of the SIMD register 202 with the data stored in the fourth SIMD lane 510 of the SIMD register 202. For instance, the SIMD coprocessor 200 may be configured to execute an instruction included in an instruction set architecture that supports intra-SIMD movement. It should be appreciated that the instruction executed by the SIMD coprocessor 200 to swap the data stored in the first SIMD lane 504 of the SIMD register 202 with the data stored in the fourth SIMD lane 510 of the SIMD register 202 may not be included in an instruction set architecture for the lane-wise SIMD coprocessor 300.

After executing the instruction to swap the data stored in the first SIMD lane 504 of the SIMD register 202 and the data stored in the fourth SIMD lane 510 of the SIMD register 202, the SIMD coprocessor 200 may be configured to return the data to the memory. For instance, the data now stored in the first SIMD lane 504 of the SIMD register 202 may be communicated to the memory 400 via data path 502 and ultimately stored in the first segment 404 of the memory 400. Additionally, the data now stored in the fourth SIMD lane 510 of the SIMD register 202 may be communicated to the memory 400 and ultimately stored in the fourth segment 422 of the memory 400.

With the data now loaded onto the memory 400, the lane-wise SIMD coprocessor 300 may execute one or more instructions included in an instruction set architecture for the lane-wise SIMD coprocessor 300. More specifically, the lane-wise SIMD coprocessor 300 may execute the instruction(s) to retrieve the data stored in the first segment 404 of the memory 400 and the data stored in the fourth segment 422 of the memory 400. More specifically, the data stored in the first segment 404 of the memory 400 may be communicated to the first SIMD lane 402 of the lane-wise SIMD register 302 via the first data path 406. Additionally, the data stored in the fourth segment 422 of the memory 400 may be communicated to the fourth SIMD lane 420 of the lane-wise SIMD register 302 via the fourth data path 424.

It should be appreciated that the data now stored in the first SIMD lane 402 of the lane-wise SIMD register 302 is the data that was previously stored in the fourth SIMD lane 420 of the lane-wise SIMD register 302. It should also be appreciated that the data now stored in the fourth SIMD lane 420 of the lane-wise SIMD register 302 is the data that was previously stored in the first SIMD lane 402 of the lane-wise SIMD register 302. Thus, the disclosed system 500 provides for intra-SIMD movement of data stored on the lane-wise SIMD register 302 of the lane-wise SIMD coprocessor 300 even though such movement is not supported by the lane-wise SIMD coprocessor 300.

### Example Technique for Executing an Instruction Packet on a Lane-Wise SIMD Coprocessor

FIG. 6 depicts a SIMD instruction packet 600 for a lane-wise SIMD coprocessor according to certain aspects of the present disclosure. For example, the SIMD instruction packet 600 may be for the lane-wise SIMD coprocessor 300 discussed above with reference to FIG. 3.

To execute the SIMD instruction packet 600, in some aspects, the lane-wise SIMD coprocessor 300 may load data from a temporary memory 602 (e.g., temporary register) that is separate from a register file (e.g., including general purpose registers) of the lane-wise SIMD coprocessor 300. Furthermore, based on the load data, the lane-wise SIMD coprocessor may execute one or more operations on one or more lane-wise SIMD registers 302 of the lane-wise SIMD coprocessor 300 and subsequently store the result of such operations in the temporary memory 602 (or a different memory location). As will be discussed below in more detail, executing the SIMD instruction packet 600 in this manner may avoid using read/write ports of the register file and, in doing so, may provide for zero-packet latency load-store operations.

The SIMD instruction packet 600 may include multiple instructions included in an instruction set architecture (ISA) for the lane-wise SIMD coprocessor 300. For instance, in some aspects, the SIMD instruction packet 600 may be a very long instruction word (VLIW) including one or more register instructions 604 and at least one of a load instruction 606 and a store instruction 608. More specifically, in some aspects, the SIMD instruction packet 600 may include the load instruction 606 and the register instruction(s) 604. In other aspects, the SIMD instruction packet 600 may include the store instruction 608 and the register instruction(s) 604. In still other aspects, the SIMD instruction packet 600 may include the load instruction 606, the register instruction(s) 604, and the store instruction 608.

The instructions included in the ISA for the lane-wise SIMD coprocessor 300 may be divided into a first subset of instructions that directly access the lane-wise SIMD registers 302 and a second subset of instruction that indirectly access the lane-wise SIMD registers 302 via one or more instructions included in the first subset of instructions. Examples of the first subset of instructions may include the register instruction(s) 604, such as arithmetic instructions (e.g., multiply instruction, add instruction, subtract instruction, divide instruction), shift instructions (e.g., right shift instruction), and sign instructions (e.g., extension, manipulation). Examples of the second subset of instructions may include the load instruction 606 and the store instruction 608.

In some aspects, the load instruction 606 may retrieve load data 610 from the temporary memory 602. The load instruction 606 may be configured to provide the load data 610 to the register instruction(s) 604. Based on the load data 610 and the register instruction(s) 604, the lane-wise SIMD coprocessor 300 may perform one or more operations on one or more of the lane-wise SIMD registers 302 thereof to generate a result 612. It should be appreciated that the operations may be executed on a lane-by-lane bases within the one or more lane-wise SIMD registers 302 such that there is no data movement between lanes of the lane-wise SIMD register(s) 302.

The result 612 may be provided to the store instruction 608 as shown. In some aspects, the store instruction 608 may be configured to store the result 612 in the temporary memory 602. For instance, the store instruction 608 may overwrite the load data 610 with the result 612. In other aspects, the store instruction 608 may be configured to store the result 612 in a different memory location. For example, the store instruction 608 may be configured to store the result 612 in a different temporary memory (e.g., a different temporary register).

The above-described manner for executing the SIMD instruction packet 600 on the lane-wise SIMD coprocessor 300 provides numerous technical effects and benefits. For instance, by having the load instruction 606 and the store instruction 608 indirectly access the lane-wise SIMD register(s) 302 of the lane-wise SIMD coprocessor 300 via the register instruction(s) 604, the disclosed techniques may avoid using read/write ports of the register file to perform load/store operations. In this manner, the load instruction 606, the register instruction(s) 604, and the store instruction 608 can be included in the same packet (e.g., a VLIW packet) without incurring the latency that is associated with traditional load-store operations that involve accessing read/write ports of the register file.

### Example Technique for Executing a SIMD Instruction Packet Including a Load Instruction and One or More Register Instructions

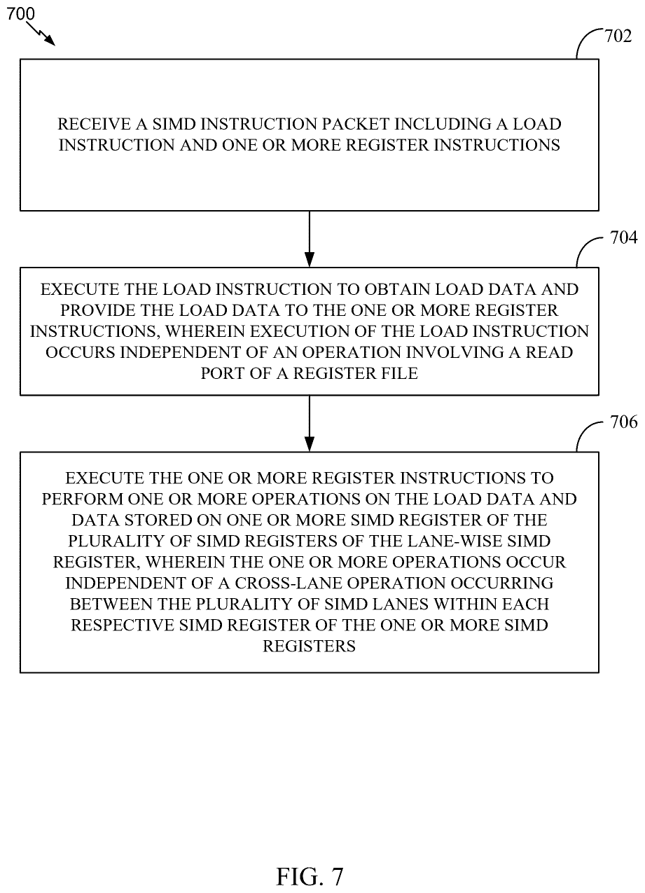

FIG. 7 is a diagram depicting an example method 700 of executing a SIMD instruction packet on lane-wise SIMD coprocessors that do not support intra-SIMD data movement according to various aspects of the present disclosure. For example, the method 700 may be performed by the lane-wise SIMD coprocessor 300 of FIG. 3 according to the technique illustrated in FIG. 6. Furthermore, although FIG. 7 depicts steps performed in a particular order for purposes of illustration and discussion, the method 700 discussed herein is not intended to be limited to any particular order or arrangement. One skilled in the art, using the disclosure provided herein, will appreciate that various steps of the method 700 can be omitted, rearranged, combined and/or adapted in various ways without deviating from the scope of the present disclosure.

Operation 702 includes receiving a SIMD instruction packet. For example, the SIMD instruction packet may be the SIMD instruction packet 600 discussed above with reference to FIG. 6. More specifically, the SIMD instruction packet 600 may include a load instruction and one or more register instructions.

Operation 704 includes executing the load instruction to obtain load data and provide the load data to the one or more register instructions, wherein execution of the load instruction occurs independent of an operation involving a read port of a register file associated with the lane-wise SIMD coprocessor. For instance, in some aspects, executing the load instruction may include obtaining the load data from a temporary memory, such as the temporary memory 602 discussed above with reference to FIG. 6, that is separate from the register file and thus does not involve accessing the read port of the register file.

Operation 706, which occurs after operation 704, includes executing the one or more register instructions to perform one or more operations (e.g., arithmetic operations, shift operations, sign operations, etc.) on the load data and data stored on one or more SIMD registers of the plurality of SIMD registers of the lane-wise SIMD coprocessor to generate a result. More particularly, the one or more operations occur independent of a cross-lane operation occurring between the plurality of SIMD lanes within each respective SIMD register of the one or more SIMD registers.

In certain aspects, the method 700 may further include provide, via the one or more register instructions, the result to the store instruction. The method 700 may even further include executing the store instruction to store the result at a memory location other than the register file. More particularly, execution of the store instruction may occur independent of an operation involving a write port of the register file.

It should be appreciated that the method 700 may allow lane-wise SIMD coprocessors to execute SIMD instruction packets, such as VLIW instructions, having a load instruction and/or a store instruction in addition to the one or more register instructions while avoiding the latency that is associated with traditional load instructions and store instructions that require accessing the register file. Thus, the disclosed method 700 allows lane-wise coprocessors to execute such SIMD instruction packets more efficiently (e.g., faster) compared to SIMDs that compute SIMD instruction packets including traditional load and/or store instructions.

### Example Technique for Executing a SIMD Instruction Packet Including a Store Instruction and One or More Register Instructions

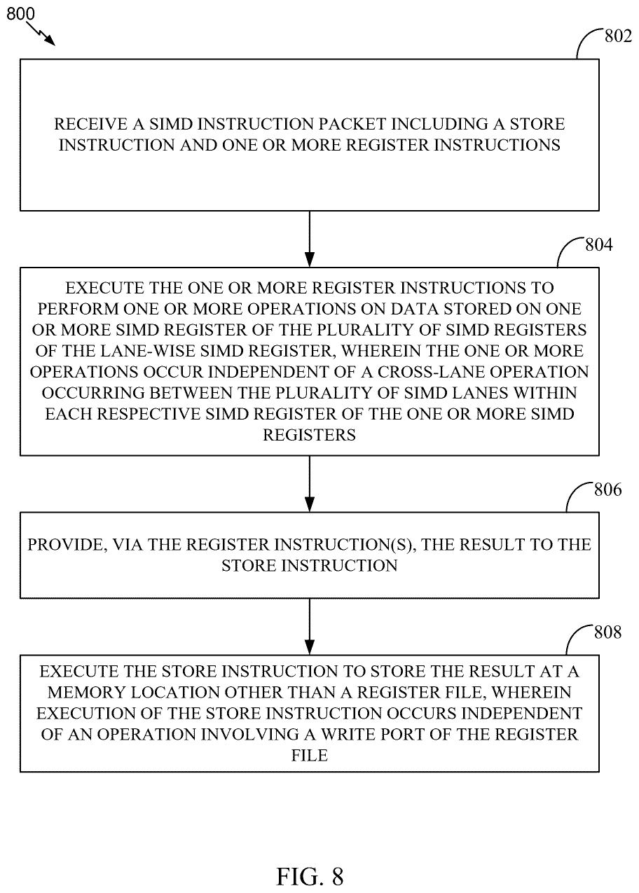

FIG. 8 is a diagram depicting an example method 800 of executing a SIMD instruction packet on lane-wise SIMD coprocessors that do not support intra-SIMD data movement according to various aspects of the present disclosure. For example, the method 800 may be performed by the lane-wise SIMD coprocessor 300 of FIG. 3 according to the technique illustrated in FIG. 6. Furthermore, although FIG. 8 depicts steps performed in a particular order for purposes of illustration and discussion, the method 800 discussed herein is not intended to be limited to any particular order or arrangement. One skilled in the art, using the disclosure provided herein, will appreciate that various steps of the method 800 can be omitted, rearranged, combined and/or adapted in various ways without deviating from the scope of the present disclosure.

Operation 802 includes receiving a SIMD instruction packet. For example, the SIMD instruction packet may be the SIMD instruction packet 600 discussed above with reference to FIG. 6. More specifically, the SIMD instruction packet 600 may include a store instruction and one or more register instructions.

Operation 804 includes executing the one or more register instructions to perform one or more operations (e.g., arithmetic operations, shift operations, sign operations, etc.) on data stored on one or more SIMD registers of the plurality of SIMD registers of the lane-wise SIMD coprocessor to generate a result. More particularly, the one or more operations occur independent of a cross-lane operation occurring between the plurality of SIMD lanes within each respective SIMD register of the one or more SIMD registers.

Operation 806 includes may further include provide, via the one or more register instructions, the result to the store instruction.

Operation 808 includes executing the store instruction to store the result at a memory location other than the register file. More particularly, execution of the store instruction may occur independent of an operation involving a write port of the register file.

### Example Processing System

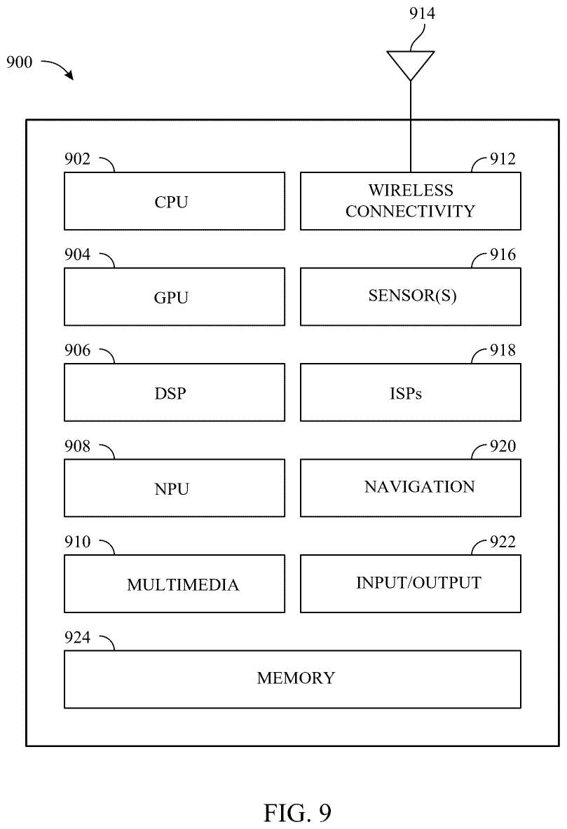

In some aspects, the heterogeneous computing system 100 discussed above with reference to FIG. 1 may be included in a device or processing system. FIG. 9 depicts an example processing system 900. Although depicted as a single system for conceptual clarity, in some aspects, as discussed above, the operations described below with respect to the processing system 900 may be distributed across any number of devices or systems.

The processing system 900 includes a central processing unit (CPU) 902. Instructions executed at the CPU 902 may be loaded, for example, from a memory 924 associated with the CPU 902.

The processing system 900 also includes additional processing components tailored to specific functions, such as a graphics processing unit (GPU) 904, a digital signal processor (DSP) 906, a neural processing unit (NPU) 908, a multimedia component 910 (e.g., a multimedia processing unit), and a wireless connectivity component 912.

An NPU, such as NPU 908, is generally a specialized circuit configured for implementing the control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 908, are configured to accelerate the performance of common machine learning tasks, such as image classification, machine translation, object detection, and various other predictive models. In some examples, a plurality of NPUs may be instantiated on a single chip, such as a SoC, while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this piece of data through an already trained model to generate a model output (e.g., an inference).

In some implementations, the NPU 908 is a part of one or more of the CPU 902, the GPU 904, and/or the DSP 906.

In some examples, the wireless connectivity component 912 may include subcomponents, for example, for third generation (3G) connectivity, fourth generation (4G) connectivity (e.g., 4G Long-Term Evolution (LTE)), fifth generation connectivity (e.g., 5G or New Radio (NR)), Wi-Fi connectivity, Bluetooth connectivity, and/or other wireless data transmission standards. The wireless connectivity component 912 is further coupled to one or more antennas 914.

The processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS), as well as inertial positioning system components.

The processing system 900 may also include one or more input and/or output devices 922, such as screens, touch-sensitive surfaces (including touch-sensitive displays), physical buttons, speakers, microphones, and the like.

In some examples, one or more of the processors of the processing system 900 may be based on an ARM or RISC-V instruction set.

The processing system 900 also includes the memory 924, which is representative of one or more static and/or dynamic memories, such as a dynamic random access memory, a flash-based static memory, and the like. In this example, the memory 924 includes computer-executable components, which may be executed by one or more of the aforementioned processors of the processing system 900.

Generally, the processing system 900 and/or components thereof may be configured to perform the methods described herein.

Notably, in other aspects, elements of the processing system 900 may be omitted, such as where the processing system 900 is a server computer or the like. For example, the multimedia component 910, the wireless connectivity component 912, the sensor processing units 916, the ISPs 918, and/or the navigation processor 920 may be omitted in other aspects. Further, aspects of the processing system 900 may be distributed between multiple devices.

### Example Clauses

In addition to the various aspects described above, specific combinations of aspects are within the scope of the disclosure, some of which are detailed below:

Aspect 1: A processing system, comprising: a lane-wise single instruction multiple data (SIMD) coprocessor including a plurality of SIMD registers, each of the plurality of SIMD registers including a plurality of SIMD lanes, wherein the lane-wise SIMD coprocessor is configured to: receive a SIMD instruction packet including a load instruction and one or more register instructions; execute the load instruction to obtain load data and provide the load data to the one or more register instructions, wherein execution of the load instruction occurs independent of an operation involving a port of a register file; execute the one or more register instructions to perform one or more operations on the load data and data stored on one or more SIMD registers of the plurality of SIMD registers to generate a result, wherein the one or more operations occur independent of a cross-lane operation occurring between the plurality of SIMD lanes within each respective SIMD register of the one or more SIMD registers.

Aspect 2: The processing system of Aspect 1, wherein the SIMD instruction packet further includes a store instruction, and wherein the SIMD coprocessor is further configured to: provide, via the one or more register instructions, the result to the store instruction; and execute the store instruction to store the result, wherein execution of the store instruction occurs independent of an operation involving a write port of the register file.

Aspect 3: The processing system of Aspect 2, wherein the load instruction is configured to obtain the load data from a temporary memory that is separate from the register file.

Aspect 4: The processing system of Aspect 3, wherein the store instruction is configured to store the result on the temporary memory.

Aspect 5: The processing system of Aspect 3, wherein the temporary memory comprises a temporary register that is separate from the plurality of SIMD registers.

Aspect 6: The processing system of any of Aspects 1 to 5, wherein the SIMD instruction packet comprises a very long instruction word (VLIW) instruction including the load instruction and two or more register operations.

Aspect 7: The processing system of any of Aspects 1 to 6, wherein the one or more register instructions comprise at least one of arithmetic instructions, shift instructions, or sign instructions.

Aspect 8: The processing system of Aspect 7, wherein the arithmetic instructions comprise one or more multiply instructions.

Aspect 9: The processing system of Aspect 7, wherein the shift instructions comprise a right shift instruction.

Aspect 10: A processing system, comprising: a lane-wise single instruction multiple data (SIMD) coprocessor including a plurality of SIMD registers, each of the plurality of SIMD registers including a plurality of SIMD lanes, wherein the lane-wise SIMD coprocessor is configured to: receive a SIMD instruction packet including a store instruction and one or more register instructions; execute the one or more register instructions to perform one or more operations on data stored on one or more SIMD registers of the plurality of SIMD registers to generate a result, wherein the one or more operations occur independent of a cross-lane operation occurring between the plurality of SIMD lanes within each respective SIMD register of the one or more SIMD registers; provide, via the one or more register instructions, the result to the store instruction; and execute the store instruction to store the result, wherein execution of the store instruction occurs independent of an operation involving a write port of a register file.

Aspect 11: The processing system of Aspect 10, wherein the store instruction is configured to store the result on a temporary memory that is separate from the register file.

Aspect 12. The processing system of Aspect 11, wherein the temporary memory comprises a temporary register that is separate from the plurality of SIMD registers.

Aspect 13: The processing system of any of Aspects 10 to 12, wherein the SIMD instruction packet comprises a very long instruction word (VLIW) instruction including the store instruction and two or more register operations.

Aspect 14: The processing system of Aspect 13, wherein the two or more register instructions comprise at least one of arithmetic instructions, shift instructions, or sign instructions.

Aspect 15: The processing system of Aspect 14, wherein the arithmetic instructions comprise one or more multiply instructions.

Aspect 16: The processing system of Aspect 14, wherein the shift instructions comprise a right shift instruction.

Aspect 17: A method performable by a lane-wise single instruction multiple data (SIMD) coprocessor, the method comprising: receiving a SIMD instruction packet including a load instruction and one or more register instructions; executing the load instruction to obtain load data and provide the load data to the one or more register instructions, wherein execution of the load instruction occurs independent of an operation involving a port of a register file; executing the one or more register instructions to perform one or more operations on the load data and data stored on one or more SIMD registers of a plurality of SIMD registers of the lane-wise SIMD coprocessor to generate a result, wherein the one or more operations occur independent of a cross-lane operation occurring between the plurality of SIMD lanes within each respective SIMD register of the one or more SIMD registers.

Aspect 18: The method of Aspect 17, wherein the SIMD instruction packet further includes a store instruction, and wherein the method further comprises: providing, via the one or more register instructions, the result to the store instruction; and executing the store instruction to store the result, wherein execution of the store instruction occurs independent of an operation involving a write port of the register file.

Aspect 19: The method of Aspect 18, wherein the load instruction is configured to obtain the load data from a temporary memory that is separate from the register file.

Aspect 20: The method of Aspect 19, wherein the store instruction is configured to store the result on the temporary memory.

### Additional Considerations

The various operations of methods described above may be performed by any suitable means capable of performing the corresponding functions. The means may include various hardware and/or software components(s) module(s), including, but not limited to a circuit or processor. Generally, where there are operations illustrated in figures, those operations may have corresponding counterpart means-plus-function components with similar numbering.

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processing system, comprising:
a lane-wise single instruction multiple data (SIMD) coprocessor including a plurality of SIMD registers, each of the plurality of SIMD registers including a plurality of SIMD lanes, wherein the lane-wise SIMD coprocessor is configured to:
receive a SIMD instruction packet including a load instruction and one or more register instructions;
execute the load instruction to obtain load data and provide the load data to the one or more register instructions, wherein execution of the load instruction occurs independent of an operation involving a port of a register file;
execute the one or more register instructions to perform one or more operations on the load data and data stored on one or more SIMD registers of the plurality of SIMD registers to generate a result, wherein the one or more operations occur independent of a cross-lane operation occurring between the plurality of SIMD lanes within each respective SIMD register of the one or more SIMD registers.

2. The processing system of claim 1, wherein the SIMD instruction packet further includes a store instruction, and wherein the SIMD coprocessor is further configured to:
provide, via the one or more register instructions, the result to the store instruction; and
execute the store instruction to store the result, wherein execution of the store instruction occurs independent of an operation involving a write port of the register file.

3. The processing system of claim 2, wherein the load instruction is configured to obtain the load data from a temporary memory that is separate from the register file.

4. The processing system of claim 3, wherein the store instruction is configured to store the result on the temporary memory.

5. The processing system of claim 3, wherein the temporary memory comprises a temporary register that is separate from the plurality of SIMD registers.

6. The processing system of claim 1, wherein the SIMD instruction packet comprises a very long instruction word (VLIW) instruction including the load instruction and two or more register operations.

7. The processing system of claim 1, wherein the one or more register instructions comprise at least one of arithmetic instructions, shift instructions, or sign instructions.

8. The processing system of claim 7, wherein the arithmetic instructions comprise one or more multiply instructions.

9. The processing system of claim 7, wherein the shift instructions comprise a right shift instruction.

10. A processing system, comprising:
a lane-wise single instruction multiple data (SIMD) coprocessor including a plurality of SIMD registers, each of the plurality of SIMD registers including a plurality of SIMD lanes, wherein the lane-wise SIMD coprocessor is configured to:
receive a SIMD instruction packet including a store instruction and one or more register instructions;
execute the one or more register instructions to perform one or more operations on data stored on one or more SIMD registers of the plurality of SIMD registers to generate a result, wherein the one or more operations occur independent of a cross-lane operation occurring between the plurality of SIMD lanes within each respective SIMD register of the one or more SIMD registers;
provide, via the one or more register instructions, the result to the store instruction; and
execute the store instruction to store the result, wherein execution of the store instruction occurs independent of an operation involving a write port of a register file.

11. The processing system of claim 10, wherein the store instruction is configured to store the result on a temporary memory that is separate from the register file.

12. The processing system of claim 11, wherein the temporary memory comprises a temporary register that is separate from the plurality of SIMD registers.

13. The processing system of claim 10, wherein the SIMD instruction packet comprises a very long instruction word (VLIW) instruction including the store instruction and two or more register operations.

14. The processing system of claim 13, wherein the two or more register instructions comprise at least one of arithmetic instructions, shift instructions, or sign instructions.

15. The processing system of claim 14, wherein the arithmetic instructions comprise one or more multiply instructions.

16. The processing system of claim 14, wherein the shift instructions comprise a right shift instruction.

17. A method performable by a lane-wise single instruction multiple data (SIMD) coprocessor, the method comprising:
receiving a SIMD instruction packet including a load instruction and one or more register instructions;
executing the load instruction to obtain load data and provide the load data to the one or more register instructions, wherein execution of the load instruction occurs independent of an operation involving a port of a register file;
executing the one or more register instructions to perform one or more operations on the load data and data stored on one or more SIMD registers of a plurality of SIMD registers of the lane-wise SIMD coprocessor to generate a result, wherein the one or more operations occur independent of a cross-lane operation occurring between the plurality of SIMD lanes within each respective SIMD register of the one or more SIMD registers.

18. The method of claim 17, wherein the SIMD instruction packet further includes a store instruction, and wherein the method further comprises:
providing, via the one or more register instructions, the result to the store instruction; and
executing the store instruction to store the result, wherein execution of the store instruction occurs independent of an operation involving a write port of the register file.

19. The method of claim 18, wherein the load instruction is configured to obtain the load data from a temporary memory that is separate from the register file.

20. The method of claim 19, wherein the store instruction is configured to store the result on the temporary memory.
